(19) United States
(12) Patent Application Publication
(10) Pub. No.: US 2007/0146584 A1
(43) Pub. Date: Jun. 28, 2007

(54) Color filter device

(75) Inventors: Chih-Yuan Wang, Shen Kan Hsiang (TW); Hui-Yu Chang, Hua Tan Hsiang (TW); Yi-Te Lee, Kao Hsiung City (TW)

Correspondence Address: BIRCH STEWART KOLASCH & BIRCH, PO BOX 747, FALLS CHURCH, VA, 22040-0747, US

(73) Assignee: WINTEK CORPORATION

(21) Appl. No.: 11/595,974

(22) Filed: Nov. 13, 2006

(30) Foreign Application Priority Data
Dec. 23, 2005 (TW) 094146114

(51) Int. Cl. G02F 1/1335

(52) U.S. Cl. 349/106

(57) ABSTRACT

A color filter device includes a transparent substrate, a phosphor layer, and a color filter layer. The phosphor layer is provided on the transparent substrate to transform incoming light having a short wavelength into white light having a broad range of wavelengths. The color filter layer is provided on the transparent substrate and has multiple filter sections for filtering the white light to generate desired light components of primary colors.

### BACKGROUND OF THE INVENTION

(a) Field of the Invention

The invention relates to a color filter device, and particularly to a color filter device for a display using a short-wavelength (10 nm-490 nm) light source as its backlight source.

(b) Description of the Related Art

FIG. 1 shows a schematic diagram illustrating a conventional color filter device. As shown in FIG. 1, the conventional color filter device 100 includes a glass substrate 102, a color filter layer 104, and an overcoat layer 106, where the color filter layer 104 and the overcoat layer 106 are sequentially provided on the glass substrate 102. The color filter layer 104 includes a red filter section 104a, a green filter section 104b, a blue filter section 104c, and a black matrix 104d provided between two neighboring filter sections for shielding light in the peripheries of sub-pixels. Each of the filter sections is distinguished by a different color of an organic pigment. When white light 108 transmits through the color filter layer 104, lights with different colors, such as red light 110, green light 112 and blue light 114, can be filtered out. By adjusting the intensities of the lights with different colors, a desired displaying color is shown after mixing these lights.

Recently, in the design of using light emitting diodes (LED) as a backlight source in combination with a light guide plate to transform a point or linear light source to a planar light source, the color of the light entering a color filter device depends on the color of the light irradiated from the light emitting diodes. Under the circumstance, since the light incident to the color filter layer 104 needs to be white light, white light emitting diodes are always used for an LED backlight module of a color display. However, the cost of the white light emitting diode is high. It has a great demand in using an LED having a short wavelength (10 nm-490 nm) for the LED backlight source, such as a blue LED or an ultraviolet LED, so as to lower the fabrication cost and to increase the intensity and the color temperature of transmission light in a color display.

### BRIEF SUMMARY OF THE INVENTION

Hence, an object of the invention is to provide a color filter device capable of coupling with a backlight source with a short wavelength in a display for not only increasing the intensity and the color temperature of transmission light in a color display to improve light transformation efficiency but also lowering the fabrication cost.

According to the invention, a color filter device includes a transparent substrate, a phosphor layer, and a color filter layer. The phosphor layer provided on the transparent substrate transforms incoming light having a short wavelength (10 nm-490 nm) into white light having a broad range of wavelengths. The color filter layer provided on the transparent substrate has multiple filter sections for filtering the white light to generate multiple light components of primary colors.

Through the design of the invention, by integrating a phosphor layer into the color filter device, a low cost LED with a short wavelength (10 nm-490 nm), such as a blue LED or an ultraviolet LED, can be used as a backlight source instead of an expensive white LED without the need of additional manufacturing processes and facilities. Therefore, the design of the invention not only lowers the fabrication cost of a backlight module but also increases the intensity and the color temperature of transmission light in a color display due to the short-wavelength LED so as to improve the light transformation efficiency.

### BRIEF DESCRIPTION OF THE DRAWINGS

The features and advantages of the invention are illustrated by way of example and are by no means intended to limit the scope of the invention to the particular embodiments shown, and in which:

FIG. 1 shows a schematic diagram illustrating the design of a conventional color filter device.

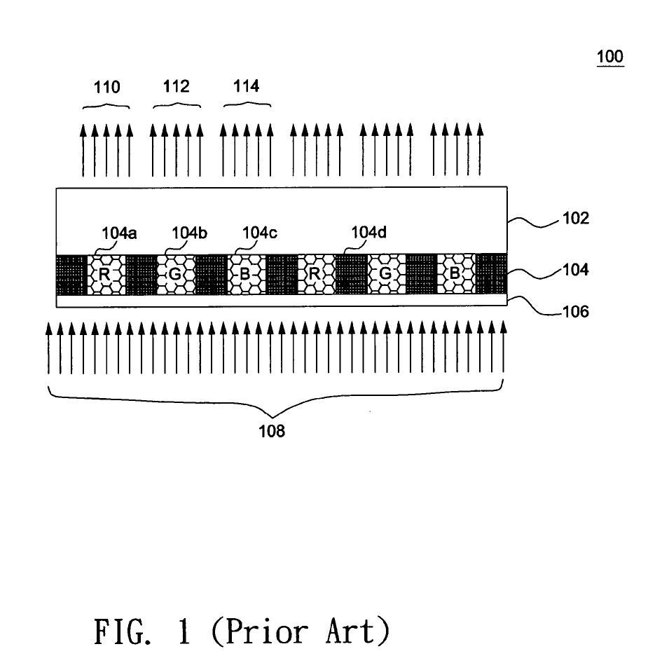

FIG. 2 shows a schematic diagram illustrating an embodiment of the invention.

FIG. 3 shows an example of transforming blue light to white light by Ce activated yttrium aluminum garnet (YAG).

FIG. 4 shows an example of transforming ultraviolet light having wavelength of 300 nm to white light by inorganic luminescent materials.

FIG. 5 shows a schematic diagram illustrating another embodiment of the invention.

FIG. 6 shows a schematic diagram illustrating another embodiment of the invention.

FIG. 7 shows a schematic diagram illustrating another embodiment of the invention.

FIG. 8 shows a schematic diagram illustrating another embodiment of the invention.

FIG. 9 shows a schematic diagram illustrating another embodiment of the invention.

FIG. 10 shows a schematic diagram illustrating another embodiment of the invention.

FIG. 11 shows a schematic diagram illustrating another embodiment of the invention, where a color filter device is used in a four-color LCD having red, green, blue, and white sub-pixels.

FIG. 12 shows a schematic diagram illustrating another embodiment of the invention, where a color filter device is used in a four-color LCD having red, green, blue, and white sub-pixels.

FIG. 13 shows a schematic diagram illustrating another embodiment of the invention, where a color filter device is used in a four-color LCD having red, green, blue, and white sub-pixels.

### DETAILED DESCRIPTION OF THE INVENTION

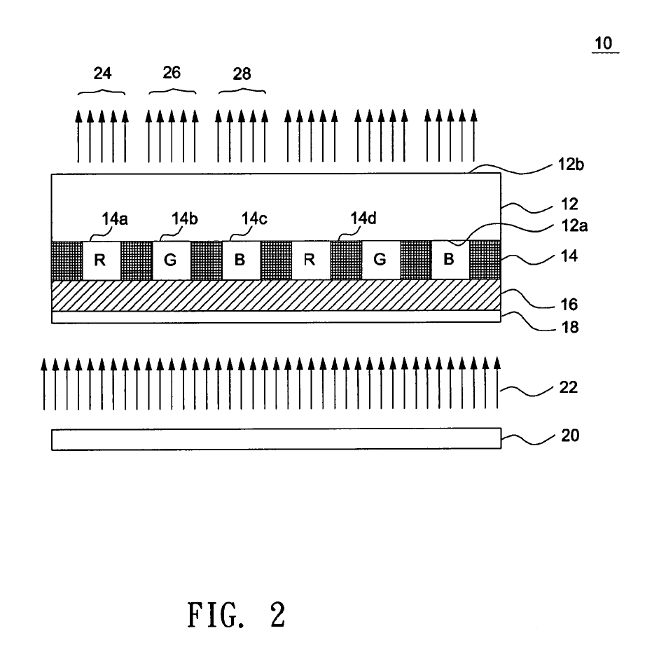

FIG. 2 shows a schematic diagram illustrating a color filter device 10 according to an embodiment of the invention. As shown in FIG. 2, the color filter device 10 includes a transparent substrate 12, a color filter layer 14, a phosphor layer 16, and an overcoat layer 18. The transparent substrate 12 is a glass substrate and has a light-receiving surface 12a facing a backlight module 20 and a light-transmitting surface 12b opposite to the light-receiving surface 12a. According to this embodiment, the color filter layer 14, the phosphor layer 16, and the overcoat layer 18 are provided sequentially on the light-receiving surface 12a of the transparent substrate 12. Note that, as used in the specification and the appended claims, the meaning of the phrase “layer A is provided on layer B” is not limited to a direct contact between the upper layer A and the lower layer B. For instance, in an embodiment where laminates are interposed between the upper layer A and the lower layer B is encompassed within the scope of the phrase “layer A is provided on layer B”.

The color filter layer 14 includes red, green, and blue filter sections 14a, 14b, and 14c, and a black matrix 14d provided between two neighboring filter sections for shielding light in the peripheries of sub-pixels. Each of the filter sections is distinguished by a different color of an organic pigment, and the phosphor layer 16 is formed from a mixture of phosphorescent materials and binder materials.

According to the invention, by including the phosphor layer 16 in the color filter device 10, the light from the backlight module 20 incident to the color filter device 10 is not limited to white light. The phosphorescent materials of the phosphor layer 16 can be the materials absorbing visible light, as the light from the backlight module 20 is visible light. For example, when the light from the backlight module 20 is blue visible light (about 400 nm-490 nm), the materials of the phosphor layer 16 can be inorganic luminescent materials that are excited by blue light, such as the following:
1. yttrium aluminum garnet (YAG);
2. terbium aluminum garnet (TAG);
3. sulfides, such as MGa₂S₂ and ZnS;
4. aluminates, such as SrAl₂O₄;
5. halides, such as Ca₁₀(PO₄)₆Cl₂;
6. rare earth borates, such as YBO₄.

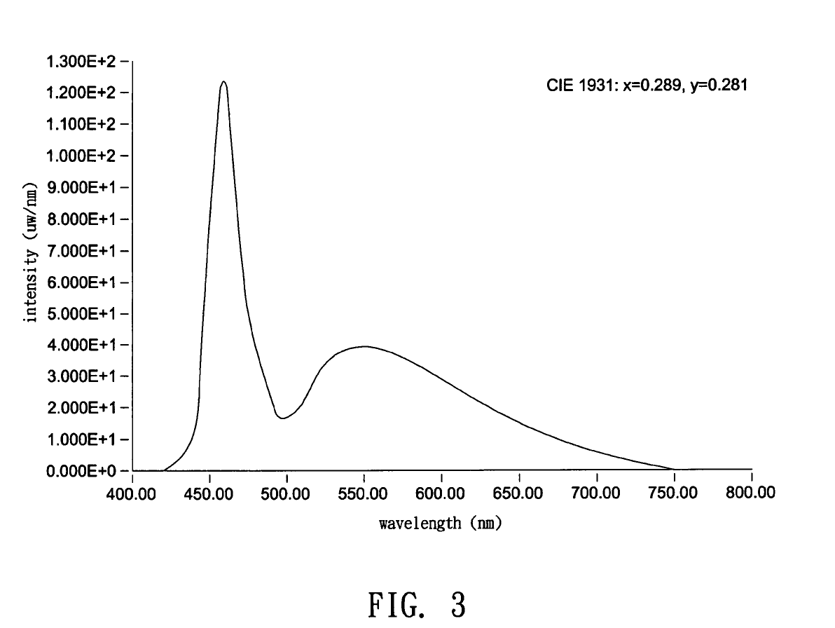

These compounds are mixed with a trace element of activation metal to have fluorescent excitation effects. The activation metal element may be cerium (Ce), europium (Eu), terbium (Tb), bismuth (Bi), or manganese (Mn). The materials for the phosphor layer 16 may also be organic luminescent materials, such as organic pigments or organic dyes. The fluorescence characteristic of the organic luminescent material depends on the number and the positions of its functional groups and the effect of the trace element. When the blue light from the backlight module 20 transmits through the phosphor layer 16, a portion of the blue light is absorbed by the luminescent material and the rest of the blue light mixes with the yellow light emitted from the luminescent material to produce white light. FIG. 3 shows a spectrum illustrating an example of transforming blue light to white light by Ce activated yttrium aluminum garnet (YAG). As shown in FIG. 3, the emitting spectrum includes a narrow band and a broad band, where the major peaks are at the blue LED emitting peak with a wavelength of 460 nm and at the YAG luminescence peak with a wavelength of 550 nm. After transformation, the white light transmits through the color filter layer 14 to filter out lights with different colors, such as red light 24, green light 26 and blue light 28. By adjusting respective intensities of the lights with different colors, a desired displaying color can be shown after mixing these lights.

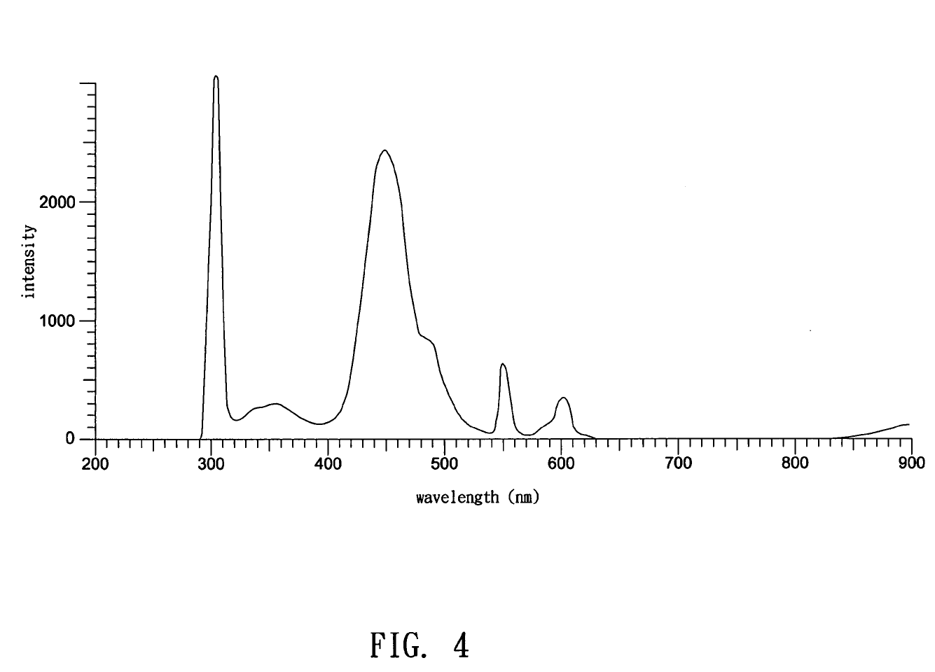

Further, the light from the backlight module 20 is not limited to visible light. For example, the light source of the backlight module 20 may be an ultraviolet LED. When the incident light is ultraviolet light (about 10 nm-380 nm) that has higher energy compared with the white light, the afore-mentioned organic or inorganic luminescent materials may also transform the ultraviolet light to the white light. In addition, silicates and vanadates also have the same functionality. Alternatively, the materials of the phosphor layer 16 may include red, green and blue phosphor materials that would respectively emit red, green and blue lights, if excited. After the red, green and blue phosphor materials with specific contents are excited by ultraviolet light, the emitted red, green and blue lights are mixed together to produce white light. FIG. 4 shows a spectrum illustrating an example of transforming ultraviolet light having a wavelength of 300 nm to white light by inorganic luminescent materials. In this case, the light transformation efficiency as well as the white light emitting efficiency is increased, since the ultraviolet light possesses high energy.

Through the design of the invention, by integrating a phosphor layer 16 into the color filter device 10, a low cost LED with a short wavelength (10 nm-490 nm), such as a blue LED or an ultraviolet LED, can be used as a backlight source instead of an expensive white LED, without the need of additional manufacturing processes and facilities. Therefore, the design of the invention not only lowers the fabrication cost of a backlight module but also increases the intensity and the color temperature of transmission light in a color display due to the short-wavelength LED so as to improve the light transformation efficiency.

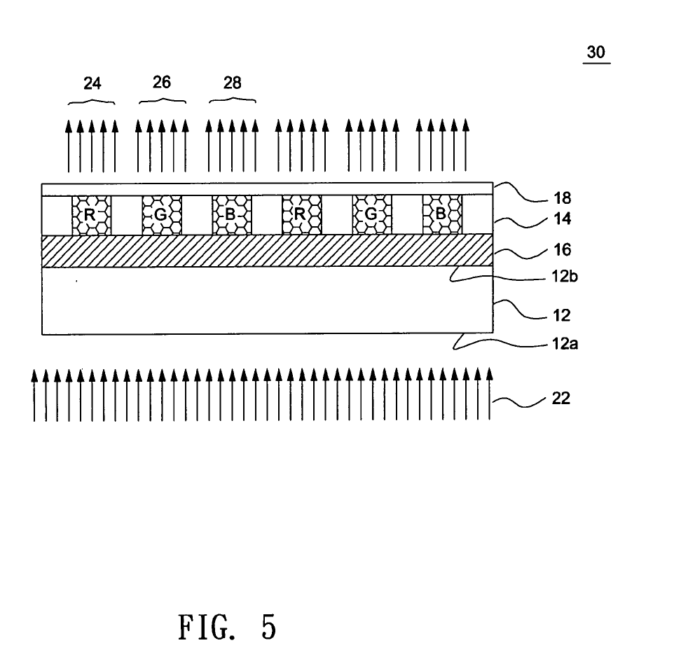

FIG. 5 shows a schematic diagram illustrating another embodiment of the invention. According to the invention, the relative positions of a color filter layer, a phosphor layer, and an overcoat layer are not limited. For example, as shown in FIG. 5, the color filter device 30 is formed by sequentially forming the phosphor layer 16, the color filter layer 14 and the overcoat layer 18 on the light-transmitting surface 12b rather than the light-receiving surface 12a of the transparent substrate 12.

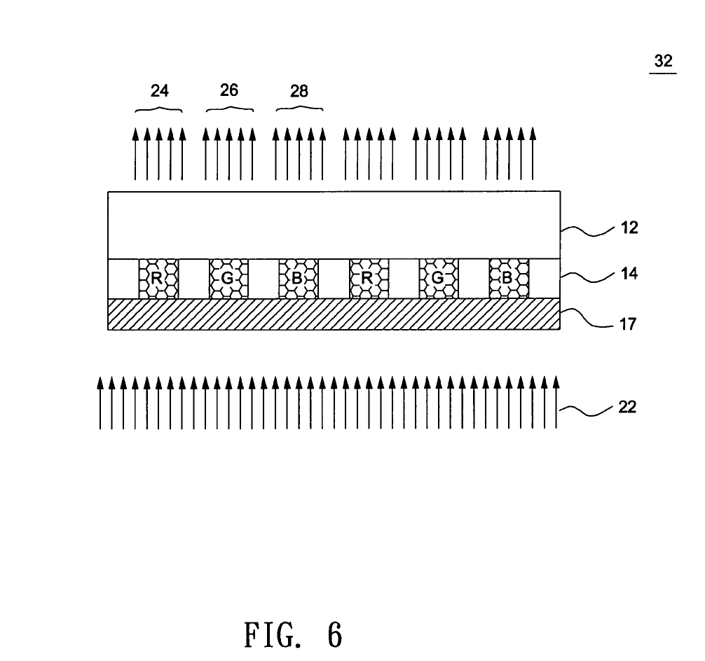

FIG. 6 shows a schematic diagram illustrating another embodiment of the invention. As shown in FIG. 6, the phosphor layer 17 in the color filter device 32 is formed from a mixture of phosphorescent materials, binder materials, and surface-protecting materials such as polyacrylate, so that the phosphor layer 17 also functions as a surface-protecting layer.

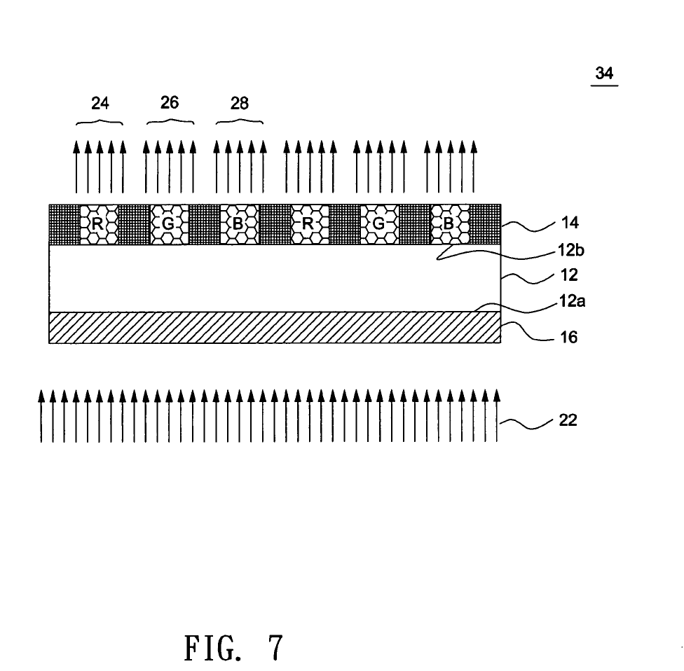

FIG. 7 shows a schematic diagram illustrating another embodiment of the invention. According to the invention, the color filter layer and the phosphor layer are not limited to be provided on the same side of the transparent substrate 12. Referring to FIG. 7, in the color filter device 34, the phosphor layer 16 is provided on the light-receiving surface 12a of the transparent substrate 12 to transform visible blue light or ultraviolet light into white light, while the color filter layer 14 is provided on the light-transmitting surface 12b of the transparent substrate 12 to filter out red light 24, green light 26, and blue light 28.

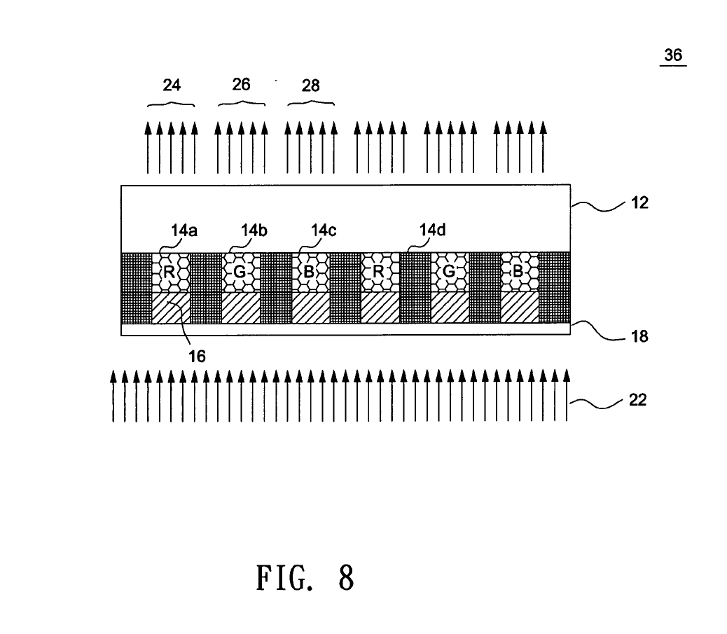

FIG. 8 shows a schematic diagram illustrating another embodiment of the invention. In all the above embodiments, the phosphor layer 16 is a planar phosphor layer covering the filter sections 14a, 14b and 14c and the black matrix 14d. However, the distribution of the phosphor layer 16 according to the invention is not limited. As shown in FIG. 8, the phosphor layer 16 in the color filter 36 is formed in multiple separate regions, each of which is positioned corresponding to only one filter section 14a, 14b or 14c, and two adjacent phosphor regions are spaced apart by the black matrix 14d, with a overcoat layer 18 covering all the phosphor regions.

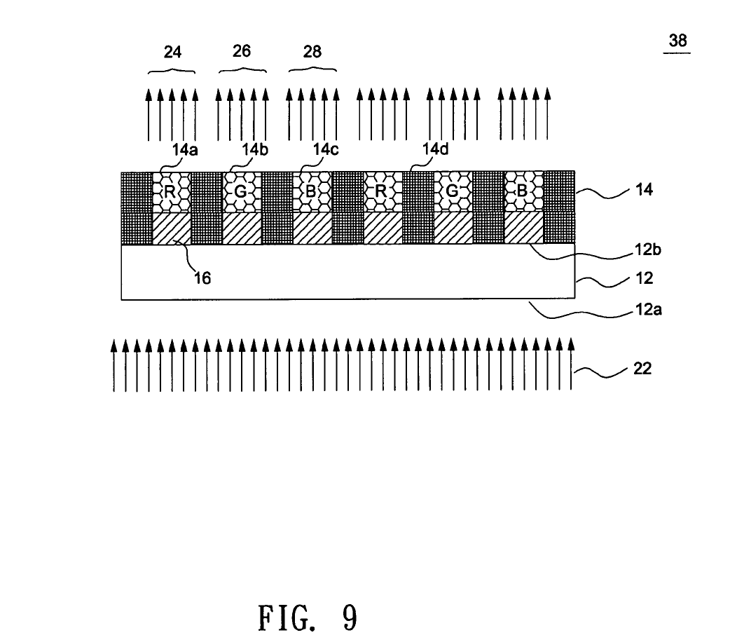

FIG. 9 shows a schematic diagram illustrating another embodiment of the invention. In the case of forming the phosphor layer 16 in multiple separate regions, the positions of the separate phosphor regions formed on the transparent substrate 12 are not limited according to the invention. As shown in FIG. 9, the separate regions of the phosphor layer 16 in the color filter device 38 are provided on the light-transmitting surface 12b of the transparent substrate 12 without the formation of the overcoat layer 18.

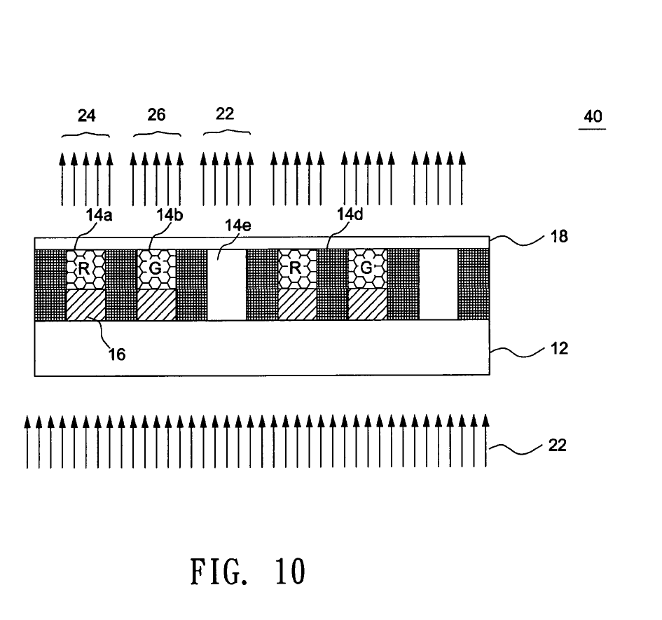

FIG. 10 shows a schematic diagram illustrating another embodiment of the invention. As shown in FIG. 10, in the color filter device 40, when the incident light is selected as blue visible light, a transparent light-transmitting section 14e can be provided to replace both the blue filter section 14c and the potion of the phosphor layer 16 corresponding to the blue filter section 14c, because the blue visible light 22 can be directly output without the need of transformation and then mixed with the output red light 24 and green light 26 to display color images. Moreover, the manner of forming the transparent light-transmitting section 14e is not limited. For example, the light-transmitting section 14e that allows for direct transmission of the blue visible light may be formed as an opening with removal of any materials, or formed as an enclosed space filled with transparent materials.

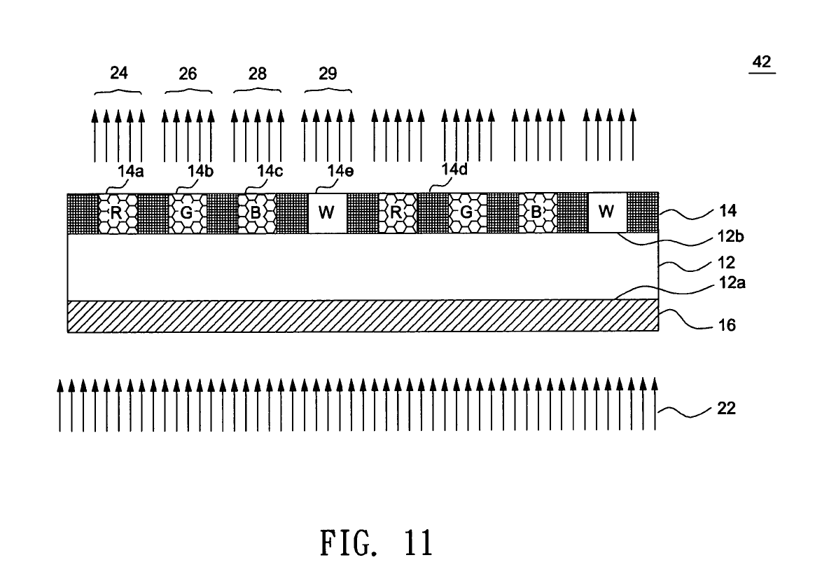

FIG. 11 shows a schematic diagram illustrating another embodiment of the invention, where a color filter device 42 is used in a four-color LCD having red, green, blue, and white sub-pixels. Referring to FIG. 11, the color filter layer 14 of the color filter device 42 further includes multiple transmissive non-color sections 14e besides the red, green and blue filter sections 14a, 14b and 14c to provide white sub-pixels capable of enhancing the panel brightness of a display. According to this embodiment, the phosphor layer 16 provided on the light-receiving surface 12a of the transparent substrate 12 transforms incident blue light or ultraviolet light 22 into white light, and then the color filter layer 14 provided on the light-transmitting surface 12b of the transparent substrate 12 filters out red light 24, green light 26 and blue light 28 by the different filter sections and meanwhile outputs the white light 29 via the non-color sections 14e to enhance panel brightness.

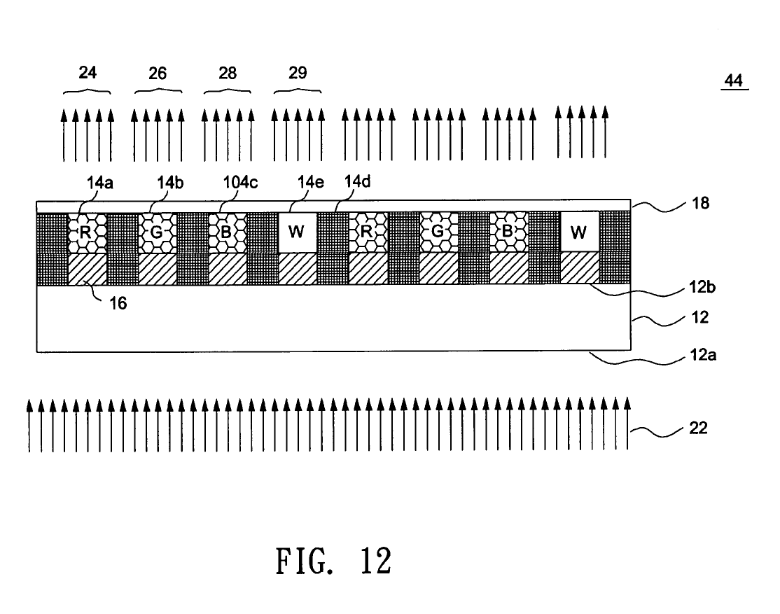

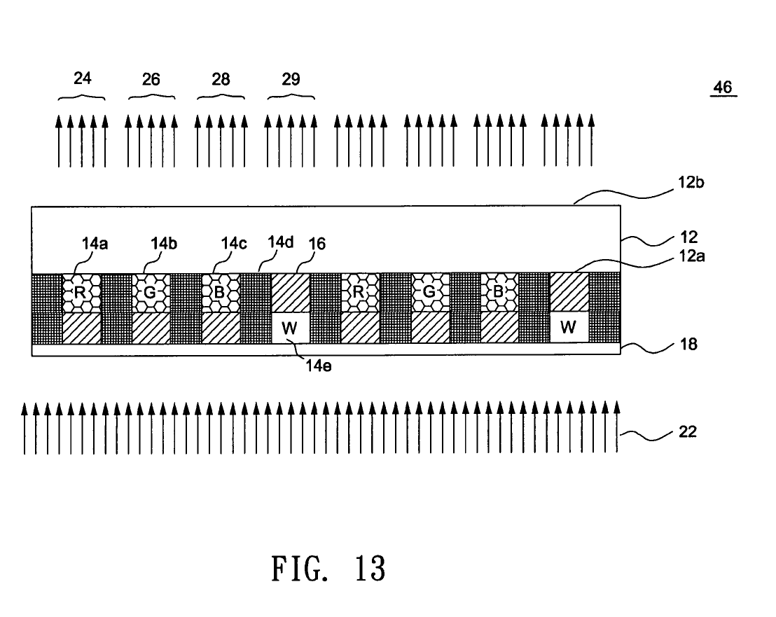

FIG. 12 shows a schematic diagram illustrating another embodiment of a color filter device 44 used in a four-color LCD. Referring to FIG. 12, the phosphor layer 16 are provided in separate regions respectively corresponding to the positions of the red, green and blue filter sections 14a, 14b and 14c and the transmissive non-color sections 14e. In this embodiment; the phosphor layer 16 and the color filter layer 14 are provided on the light-transmitting surface 12b of the transparent substrate 12, as shown in FIG. 12; alternatively, they may be provided on the light-receiving surface 12a of the transparent substrate 12, as shown in FIG. 13. Besides, it can be seen the position of the separate phosphor region corresponding to the transmissive non-color section 14e can be altered, as illustrated in the different embodiments shown in FIGS. 12 and 13.

While the invention has been described by way of examples and in terms of the preferred embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A color filter device, comprising:
a transparent substrate;
a phosphor layer provided on the transparent substrate to transform incoming light having a short wavelength into white light having a broad range of wavelengths; and
a color filter layer provided on the transparent substrate and having multiple filter sections for filtering the white light to generate multiple light components of primary colors.

2. The color filter device as claimed in claim 1, wherein the filter sections include red, green, and blue filter sections.

3. The color filter device as claimed in claim 1, further comprising an overcoat layer provided on the phosphor layer or on the color filter layer.

4. The color filter device as claimed in claim 1, wherein the phosphor layer is formed from a mixture of phosphorescent materials and binder materials.

5. The color filter device as claimed in claim 1, wherein the transparent substrate has a light-receiving surface and a light-transmitting surface opposite to the light-receiving surface, the phosphor layer is provided on the light-receiving surface, and the color filter layer is provided on the light-transmitting surface.

6. The color filter device as claimed in claim 1, wherein the transparent substrate has a light-receiving surface and a light-transmitting surface opposite to the light-receiving surface, and both of the phosphor layer and the color filter layer are provided on either the light-receiving surface or the light-transmitting surface.

7. The color filter device as claimed in claim 1, wherein the color filter layer further comprises a black matrix provided between each two neighboring filter sections, and the phosphor layer is a planar phosphor layer covering the filter sections and the black matrix.

8. The color filter device as claimed in claim 1, wherein the color filter layer further comprises a black matrix provided between each two neighboring filter sections, and the phosphor layer is formed in multiple separate regions positioned corresponding to only the filter sections.

9. The color filter device as claimed in claim 1, wherein the light having a short wavelength is blue visible light.

10. The color filter device as claimed in claim 9, wherein the phosphor layer is formed from inorganic luminescent materials selected from the group consisting of yttrium aluminum garnet (YAG), terbium aluminum garnet (TAG), sulfides, aluminates, halides, and rare earth borates.

11. The color filter device as claimed in claim 9, wherein the phosphor layer include activation metal element selected from the group consisting of cerium (Ce), europium (Eu), terbium (Tb), bismuth (Bi), and manganese (Mn).

12. The color filter device as claimed in claim 9, wherein the phosphor layer is formed from organic luminescent materials.

13. The color filter device as claimed in claim 9, wherein the filter sections include only red filter sections and green filter sections, and the color filter layer further comprises a plurality of transparent light-transmitting sections, with the phosphor layer being positioned corresponding to only the red and the green filter sections.

14. The color filter device as claimed in claim 13, wherein each transparent light-transmitting section is formed as an opening or an enclosed space filled with transparent materials.

15. The color filter device as claimed in claim 1, wherein the light having a short wavelength is ultraviolet light.

16. The color filter device as claimed in claim 15, wherein the phosphor layer is formed from inorganic luminescent materials selected from the group consisting of yttrium aluminum garnet (YAG), terbium aluminum garnet (TAG), sulfides, aluminates, halides, rare earth borates, silicates, and vanadates.

17. The color filter device as claimed in claim 15, wherein the phosphor layer include activation metal element selected from the group consisting of cerium (Ce), europium (Eu), terbium (Tb), bismuth (Bi), and manganese (Mn).

18. The color filter device as claimed in claim 15, wherein the phosphor layer is formed from organic luminescent materials.

19. A color filter device, comprising:
a transparent substrate;
a phosphor layer provided on the transparent substrate to transform incoming light having a short wavelength into white light having a broad range of wavelengths; and
a color filter layer provided on the transparent substrate and having multiple filter sections and transmissive non-color sections;
wherein the filter sections filter the white light to generate multiple light components of primary colors, and the white light directly transmits through the non-color sections to enhance the panel brightness of a display.

20. The color filter device as claimed in claim 19, further comprising:
an overcoat layer provided on the phosphor layer or on the color filter layer.

21. The color filter device as claimed in claim 19, wherein the color filter layer further comprises light-shielding structures, and the phosphor layer is a planar phosphor layer covering the filter sections, the transmissive non-color sections, and the light-shielding structures.

22. The color filter device as claimed in claim 19, wherein the color filter layer further comprises light-shielding structures, and the phosphor layer is formed in multiple separate regions positioned corresponding to only the filter sections and the transmissive non-color sections.

23. The color filter device as claimed in claim 19, wherein the light having a short wavelength is blue visible light or ultraviolet light.
